(19) United States
(12) Patent Application Publication
(10) Pub. No.: US 2024/0371055 A1
(43) Pub. Date: Nov. 7, 2024

(54) IMPROVED MOTION ARTIFACT COMPENSATION THROUGH METAL ARTIFACT REDUCTION

(71) Applicant: DENTSPLY SIRONA Inc., York, PA (US)

(72) Inventors: Susanne MAUR, Bensheim (DE); Markus HUELSBUSCH, Burstadt (DE)

(73) Assignee: DENTSPLY SIRONA Inc., York, PA (US)

(21) Appl. No.: 18/291,465

(22) PCT Filed: Jun. 27, 2022
(86) PCT No.: PCT/EP2022/067560

§ 371 Date: Jan. 23, 2024

(30) Foreign Application Priority Data
Jul. 26, 2021 (EP) 21187663.6

(51) Int. Cl. G06T 11/00

(52) U.S. Cl. CPC G06T 11/008; G06T 11/005; G06T 2210/41; G06T 2211/424; G06T 2211/448

(57) ABSTRACT

A method for geometric calibration of a DVT imaging in the dental field, including: (S1) reconstruction of a first volume from a sinogram with an initial projection geometry; (S2) detection of metal areas in the sinogram; (S3) correction of the metal areas in the sinogram; (S4) reconstruction of a second volume from the corrected sinogram from step (S3) with the initial or a varied projection geometry; (S5) geometrically calibrating by varying the projection geometry and evaluating by a similarity measure between a simulated sinogram of the reconstructed second volume and the sinogram or the corrected sinogram.

### TECHNICAL FIELD OF THE INVENTION

The present invention relates to methods for digital volume tomography (DVT) in the dental field. In particular, the present invention relates to a reduction of motion artifacts in a DVT imaging.

### BACKGROUND OF THE INVENTION

In a DVT imaging, the imaging components X-ray source and X-ray detector face each other and rotate around the patient. A sequence of X-ray projection images is generated, which form a sinogram. Knowing the projection geometry, a volume is reconstructed from the sinogram. The projection geometry describes the geometric properties of the DVT device and its trajectory during the exposure. It can be expressed by means of projection matrices.

In a DVT imaging, X-ray opaque structures such as metals lead to image artifacts in the reconstructed volume. The image artifacts occur when the sensitivity of the X-ray detector is not sufficient to image the X-ray attenuation physically accurately enough. This leads to problems especially behind highly absorbing structures such as metals, where noise predominates. This leads to inconsistent values in the reconstruction procedure, which are often represented by fringe artifacts around the metal regions, incorrect absorption values in the metal regions and incorrectly imaged metal contours in the volume.

If the patient moves during the DVT acquisition or if the device calibration is outdated, the wrong projection geometry is applied in the reconstruction procedure. This leads to motion artifacts in the reconstructed volume due to the accounting of inconsistent data. A motion artifact compensation (MAC) procedure, or geometric calibration of the image, can estimate the projection geometry from a given patient image. The metal artifacts interfere with the convergence and/or accuracy of the MAC, as it performs an estimate of the projection geometry based on a similarity measure between a simulated sinogram of the reconstructed volume and the measured sinogram. The simulated sinogram is generated by projecting the artifact-affected volume. The metal artifacts lead to strong data inconsistencies.

### DISCLOSURE OF THE INVENTION

The object of the present invention is to provide a method for geometric calibration of a digital volume tomography (DVT) imaging in the dental field, which can provide improved motion artifact compensation (MAC) through metal artifact reduction (MAR).

This objective is achieved by the method according to claim 1. The subject-matters of the dependent claims relate to further developments and preferred embodiments.

The method according to the invention is used for geometric calibration of a DVT imaging in the dental field. It comprises the following steps: (S1) reconstruction of a first volume from a sinogram with an initial projection geometry; (S2) detection of the metal regions in the sinogram; (S3) correction of the metal regions in the sinogram; (S4) reconstruction of a second volume from the corrected sinogram from step (S3) with the initial or a varied projection geometry; (S5) geometrically calibrating by varying the projection geometry and evaluating by a similarity measure between a simulated sinogram of said reconstructed second volume and said sinogram or the corrected sinogram, wherein the simulated sinogram is calculated from the reconstructed second volume using the varied projection geometry; wherein at least a partial region of the following data: (a) sinogram from step (S1); (b) corrected sinogram from step (S3); (c) simulated sinogram; (d) intermediate result for calculating the similarity measure derived from at least one of said sinograms (a)-(c) being evaluated differently during the calculation of the similarity measure than the remaining regions of the data, said partial region including the metal regions from step (S2).

A key feature of the present invention is the use of a metal artifact correction to reconstruct the volume used in the MAC, and the improvement of the MAC by special treatment preferably filtering/weighting of the metal regions during the calculation of the similarity measure. Another significant beneficial effect of the present invention is the increased accuracy and faster convergence of the MAC.

### BRIEF DESCRIPTION OF THE DRAWINGS

In the following description, the present invention will be explained in more detail with reference to exemplary embodiments and with reference to the drawings, wherein.

FIG. 1—shows an overview of the method for geometric calibration of a DVT imaging in the dental area according to one embodiment;

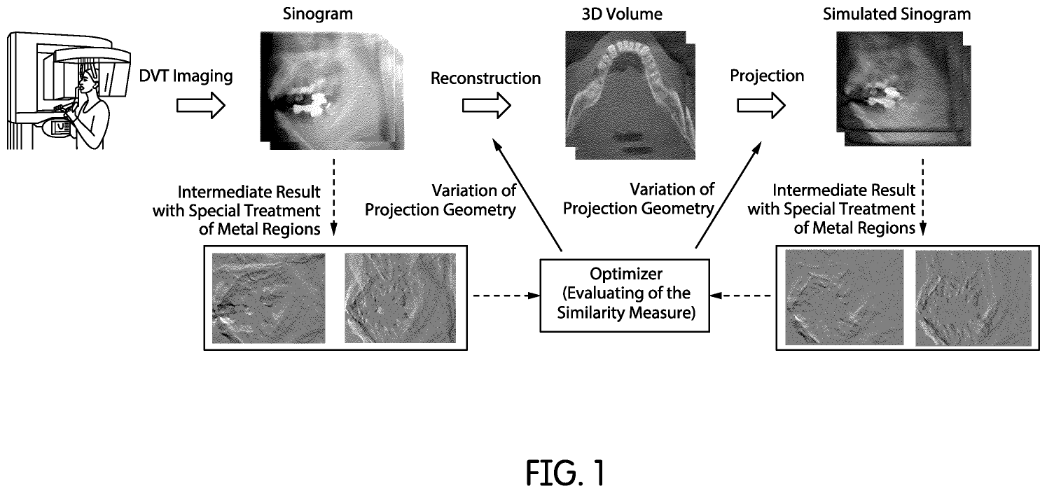

FIG. 2—shows a flow diagram according to a further embodiment;

FIG. 3—shows a flow diagram according to a further embodiment;

FIG. 4—shows a flow diagram according to a further embodiment;

FIG. 5—shows a flow diagram according to a further embodiment;

FIG. 6—shows a computer-aided DVT system on which the method according to the invention can be carried out.

The reference numerals shown in the drawings designate the elements listed below, which will be referred to in the following description of the exemplary embodiments.
1. DVT system
2. X-ray device
3. X-ray source
4. X-ray detector
5. Control unit
6. Head fixation
7. Bite
8. Computer
9. Display

### Definitions

I₁, I₂: Projection images
Ī: Mean value of image I
N Number of pixels in the projection image
I(u,v): pixel value of the projection image Iat the position (u,v)
s(I₁, I₂): Similarity measure for projection images
MSE(I₁, I₂): Mean Square Error
MAD(I₁, I₂): Mean Absolute Difference
NCC1(I₁, I₂): Normalized Cross Correlation
NCC2(I₁, I₂): Pixel-based Normalized Cross Correlation
GC1(I₁, I₂): Gradient Correlation 1
GC2(I₁, I₂): Gradient Correlation 2
GI1(I₁, I₂) Gradient Information
GI2(I₁, I₂) Gradient Information with linear Scaling
GO(I₁, I₂) Gradient Orientation
LoG: Laplace of Gaussian
MI(A, B) Mutual Information

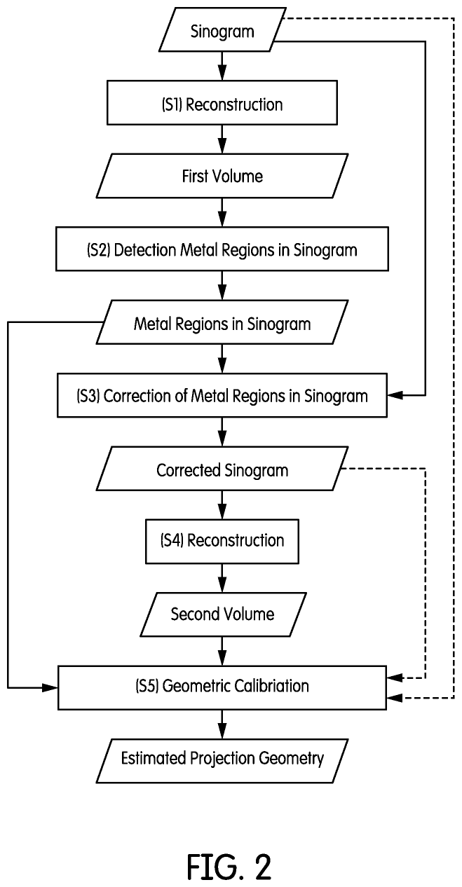

The method according to the invention is used for geometric calibration of a DVT imaging in the dental field. As shown in FIG. 2, it comprises the following steps: (S1) reconstruction of a first volume (1) from a sinogram with an initial projection geometry; (S2) detection of the metal regions in the sinogram; (S3) correction of the metal regions in the sinogram; (S4) reconstruction of a second volume (2) from the corrected sinogram from step (3) with the initial or a varied projection geometry; (S5) geometric calibration by varying the projection geometry and evaluating by a similarity measure between a simulated sinogram of the reconstructed second volume (2) and said sinogram or the corrected sinogram, wherein the simulated sinogram is calculated from the reconstructed second volume (2) using the varied projection geometry, wherein at least a partial region of the following data: (a) sinogram from step (S1); (b) corrected sinogram from step (S3); (c) simulated sinogram; (d) intermediate result for calculating the similarity measure derived from one of said sinograms (a)-(c) being evaluated differently from the remaining regions of the data during the calculation of the similarity measure, said partial region including the metal regions from step (S2).

Metals or artificial, X-ray opaque structures form distinct contours in the sinogram. In the simulated sinogram, these contours are usually indistinct or distorted due to the inaccurate projection geometry in the reconstruction procedure, the missing physical information in the metal regions, and the metal artifacts in the reconstructed volume. By using a metal artifact reduction (MAR) in steps (S2)-(S4), the metal artifacts in the reconstructed volume can be reduced, but usually not completely or physically correctly recovered. These inconsistent metal regions hinder the convergence of geometric calibration, or motion artifact correction (MAC). By evaluating the metal regions differently during the calculation of the similarity measure, the convergence of the geometric calibration can be improved and, in many cases, accelerated, as well as its accuracy increased. The partial regions in step (S5) are preferably larger than the detected metal regions from step (S2), so that artifacts at the edges of the metal regions can also be detected. The correction of the metal regions in the sinogram in step (S3) can also be performed on larger regions to compensate for inaccuracies in the detection of the metal regions in step (S2).

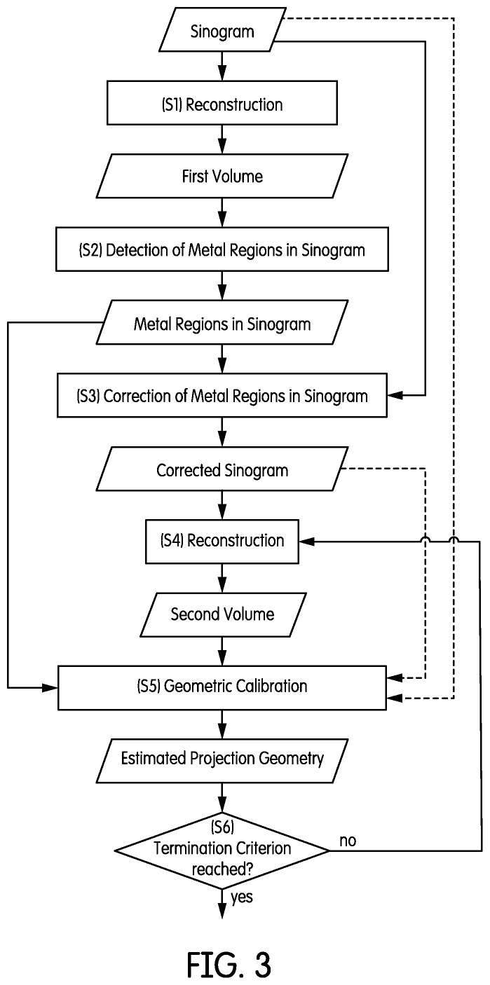

FIG. 3 shows a preferred embodiment in which the method comprises, after step (S5), the following step: (S6) repeating steps (S4)-(S5). This is for iterative improvement of the MAC. The iterative repetition is terminated when a termination criterion, or convergence criterion, is reached. Possible termination criteria are: a) whether the change in projection geometry is less than a threshold; b) whether the change in the final volume is less than a threshold; c) whether the number of iteration steps is greater than a threshold; d) whether the computation time is greater than a threshold.

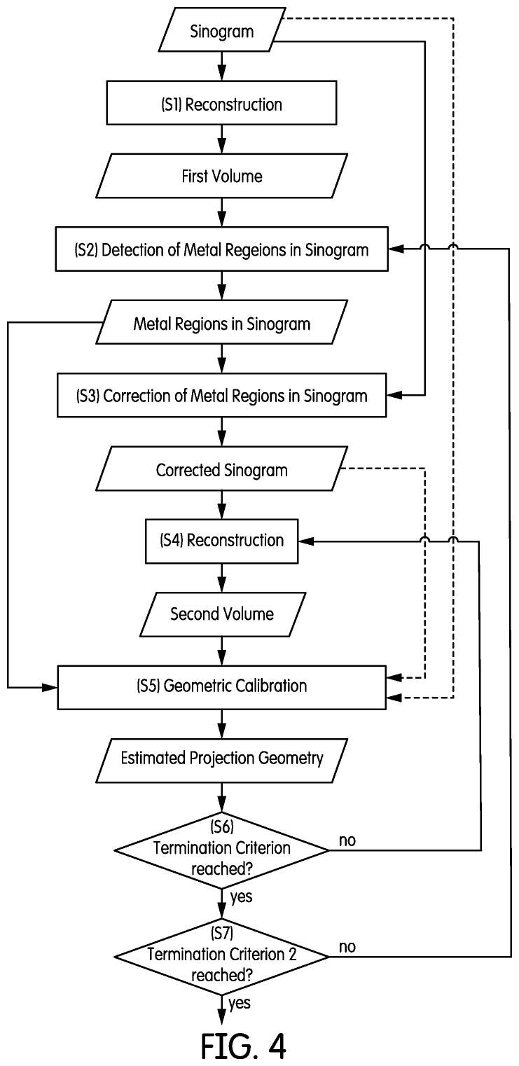

In another preferred embodiment, after step (S5), the method comprises the following step: (S7) repeating steps (S2)-(S5) or (S2)-(S6). This serves to iteratively improve the MAR by using the intermediate result of the MAC. This also implies an iterative improvement of the MAC. The iterative repetition is terminated when a second termination criterion, or convergence criterion, is reached. Possible second termination criteria are: a) whether the change in projection geometry is less than a threshold; b) whether the change in the final volume is less than a threshold; c) whether the number of iteration steps is greater than a threshold; d) whether the computation time is greater than a threshold, e) whether the amount of metal in the volume or sinogram is greater than a threshold. FIG. 4 illustrates this embodiment combined with previous preferred embodiments.

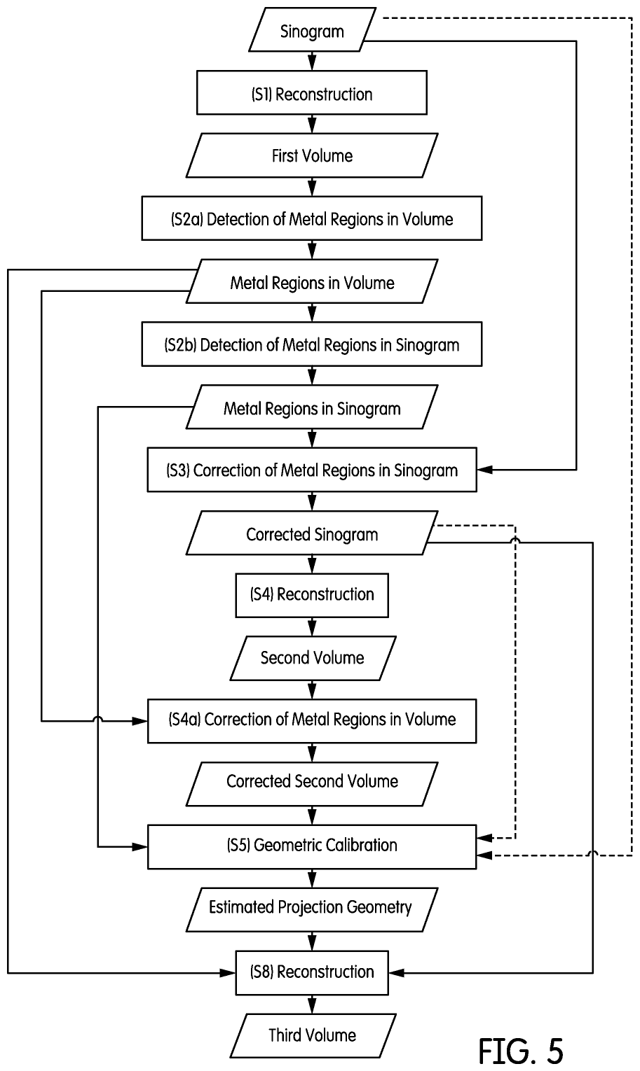

In a further preferred embodiment, the method comprises, after step (5), the following step: (S8) reconstructing a third volume (3) taking into account the estimated projection geometry and applying a metal artifact correction. The third volume takes into account the results of the MAR and MAC correction methods. FIG. 5 shows this embodiment combined with other preferred embodiments.

In another preferred embodiment, the detection of the metal regions in the sinogram in step (S2) comprises: (a) detecting the metal regions in the first volume (1); and (b) projecting the detected metal regions into the sinogram. Detection of the metal regions in the volume has the advantage that it is usually more robust or easier to implement than direct detection of the metal regions in the sinogram. By applying the projection geometry, or estimated projection geometry, the detected metal regions can be transferred to the sinogram. The metal regions detected in the volume can be enlarged to compensate for inaccurate projection geometry and/or inaccurate detection of the metal regions.

In another preferred embodiment, the detection of the metal regions in the sinogram in step (2) comprises: (a) generating a simulated sinogram of the first volume (1); and (b′) detecting the metal regions in the simulated sinogram from step (S2)(a) and transferring the detected metal regions to the sinogram. Detection of the metal regions in the simulated sinogram is simpler than in the sinogram because a simplified representation of the superimposed structures is possible when generating the simulated sinogram. The metal areas detected in the simulated sinogram can be transferred to the sinogram because the projection geometries estimated for the sinogram were used in the generation of the simulated sinogram.

In a further preferred embodiment, the method comprises, after step (S4), the step of: (a) determining the metal regions in the second volume (2) using the detected metal regions in the sinogram. The determination of the metal regions in the second volume is performed by back-projecting or reconstructing the detected metal regions in the sinogram using the projection geometry, or the estimated projection geometry. This step is required if the detection of the metal regions in the simulated sinogram has been performed.

In a further preferred embodiment, the method comprises, after step (S4), the step of: (b) correcting the metal regions in the second volume (2) which in turn comprises one or more of the following steps: (b1) filling the metal regions in the second volume (2) with values from the reconstructed first volume (1) or artificial values indicative of the metal regions; (b2) blending the values from step (S4)(b1) with the values from the second volume (2) in a weighted manner. This has the advantage that the metal regions in the simulated sinogram in step (S5) are more suitable for comparison with the sinogram and calculation of the similarity measure. FIG. 5 shows this embodiment combined with other preferred embodiments.

In a further preferred embodiment, the correction of the metal regions in the sinogram in step (S3) comprises one or more of the following steps: (a) filling the metal regions in the corrected sinogram with new pixel values, which are either calculated from the neighboring pixels or correspond to artificial pixel values;
(b) weighted blending of the new pixel values from step (S3)(a) with the pixel values of the sinogram. The metal regions in the sinogram cannot be physically measured correctly due to strong absorption. By replacing them with plausible pixel values, the occurrence of metal artifacts during reconstruction can be avoided. The new plausible pixel values can be artificial values or calculated from neighboring pixels in the sinogram. A weighted blending of the new pixel values with the original pixel values preserves some of the uncertain physical information.

In a further preferred embodiment, the different evaluation of the partial regions in at least one of said data during the calculation of the similarity measure in step (S5) comprises a pixel-wise weighting, which is preferably in the value range 0 to 1. This has the advantage that the metal regions and their surroundings are more weakly included in the calculation of the similarity measure and thus do not hinder the convergence of the MAC or do not hinder it so much.

In a further preferred embodiment, the different evaluation of the partial regions in at least one of said data during the calculation of the similarity measure in step (S5) comprises a local filtering. This has the advantage that the metal regions and their surroundings are more weakly included in the calculation of the similarity measure and thus do not hinder the convergence of the MAC or do not hinder it so much.

In a further preferred embodiment, the projection geometry or the estimated projection geometry of the DVT imaging relative to the patient head is described by geometric parameters. The projection geometry is preferably described by intrinsic parameters and extrinsic parameters, wherein the intrinsic parameters comprise the relative position between the X-ray source and the X-ray detector as well as their resolution, and the extrinsic parameters comprise a transformation consisting of rotation and translation per projection image and selected sub-region of the volume.

In a further preferred embodiment, in addition to the image data, an initial projection geometry, e.g. in the form of data from a device calibration, may be provided as input data to the geometric calibration procedures (step S5).

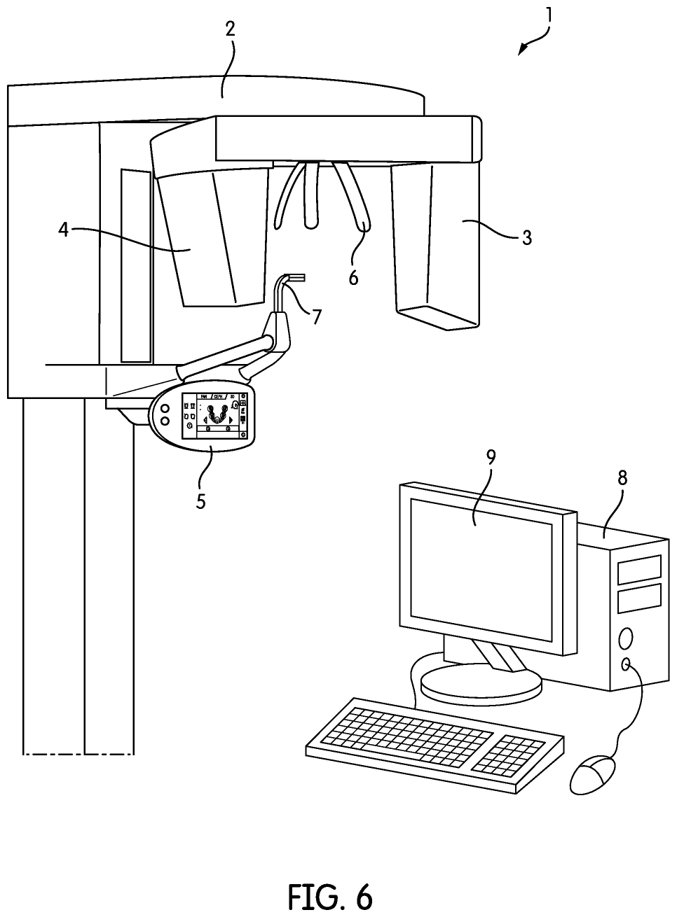

The method according to the invention is a computer implementable method, and can be executed on a computerized DVT system (1). FIG. 6 shows an example of an embodiment for a DVT system (1). In this regard, the present invention also includes a computer program having computer-readable code. The computer program may be provided on a data storage device. The computerized DVT system (1) comprises an X-ray device (2) for performing the patient imaging, whereby the sinogram is generated. The X-ray device (2) has an X-ray source (3) and X-ray detector (4), which are rotated around the patient's head during the exposure. The trajectory of the X-ray source (3) and X-ray detector (4) during the exposure may describe a circular path. Alternatively, it may assume a shape deviating therefrom. If several actuators are controlled simultaneously, a device trajectory around the patient's head that deviates from a pure circular path can be achieved. The patient's head is positioned in the X-ray device with the bite (7) and the head fixation (6).

The computerized DVT system (1) comprises a control unit (5), preferably a computer (8) or a computing unit connectable to the X-ray device (2), and preferably a display (9), inter alia to visualize the data sets. The computer (8) may be connected to the X-ray device (2) via a local area network (not shown) or alternatively via the Internet. The computer (8) may be part of a cloud. Alternatively, the computer (8) may be integrated into the X-ray apparatus (2). The computations may alternatively take place in the cloud.

The computer (8) executes the computer program and provides the data sets, including for visualization on the display (9). The display (9) may be spatially separated from the X-ray device (2). Preferably, the computer (8) may also control the X-ray device (2). Alternatively, separate computers may be used for the control and the reconstruction.

According to the present invention, the data sets generated by the above embodiments may be presented to a physician for visualization, in particular for diagnostic purposes, preferably by means of a display (9) or printout.

### Similarity Measure

In the following, the similarity measures s(I₁, I₂) are explained in detail. The similarity measure is a scalar quantity that describes a similarity between two projection images I₁, I₂ Instead of similarity measures, negated difference measures can also be used. Similarity measures can be divided into two classes: Pixel-based similarity measures and Histogram-based similarity measures.

Examples on pixel-based similarity measures:
a) Mean Square Error

$$MSE ( {I}_{1} , {I}_{2} ) = \sqrt{\frac{1}{N} {\sum }_{u , v ∈ I} {( {I}_{1} ( u , v ) - {I}_{2} ( u , v ) )}^{2}}$$

b) Mean Absolute Difference

$$MAD ( {I}_{1} , {I}_{2} ) = \frac{1}{N} {\sum }_{u , v ∈ I} \vert {KI}_{1} ( u , v ) - {I}_{2} ( i , v ) \vert$$

c) Normalized Cross Correlation

$$NCC 1 ( {I}_{1} , {I}_{2} ) = \frac{{Σ}_{u , v ∈ I} ( {I}_{1} ( u , v ) - \overline{{I}_{1}} ) ( {I}_{2} ( u , v ) - \overline{{I}_{2}} )}{\sqrt{{{Σ}_{u , v ∈ I} ( {I}_{1} ( u , v ) - \overline{{I}_{1}} )}^{2}} \sqrt{{{Σ}_{u , v ∈ I} ( {I}_{2} ( u , v ) - \overline{{I}_{2}} )}^{2}}}$$

d) Pixel-based Normalized Cross Correlation

$$NCC 2 ( {I}_{1} , {I}_{2} ) = {\sum }_{u , v ∈ I} \frac{( {I}_{1} ( u , v ) - \overline{{I}_{1}} ) ( {I}_{2} ( u , v ) - \overline{{I}_{2}} )}{‖ ( {I}_{1} ( u , v ) - \overline{{I}_{1}} ) ‖ ‖ ( {I}_{2} ( u , v ) - \overline{{I}_{2}} ) ‖}$$

e) Gradient Correlation 1

$$GC 1 ( {I}_{1} , {I}_{2} ) = \frac{1}{2} ( NCC 1 ( \frac{\partial {I}_{1}}{\partial u} , \frac{\partial {I}_{2}}{\partial u} ) + NCC 1 ( \frac{\partial {I}_{1}}{\partial v} , \frac{\partial {I}_{2}}{\partial v} ) ) , with NNC 1 from c ) .$$

f) Gradient Correlation 2

$$GC 2 ( {I}_{1} , {I}_{2} ) = \frac{1}{2} ( NCC 2 ( \frac{\partial {I}_{1}}{\partial u} , \frac{\partial {I}_{2}}{\partial u} ) + NCC 2 ( \frac{\partial {I}_{1}}{\partial v} , \frac{\partial {I}_{2}}{\partial v} ) ) , with NNC 2 from f ) .$$

g) Gradient information

$$GI 1 ( {I}_{1} , {I}_{2} ) = \frac{1}{N} {\sum }_{u , v ∈ I} g ( u , v ) min ( \sqrt{\frac{\partial {I}_{1}^{2}}{\partial u} + \frac{\partial {I}_{1}^{2}}{\partial v}} , \sqrt{\frac{\partial {I}_{2}^{2}}{\partial u} + \frac{\partial {I}_{2}^{2}}{\partial v}} )$$

$$with g ( u , v ) = \frac{θ ( u , v ) + 1}{2} and θ ( u , v ) = \frac{\frac{\partial {I}_{1}}{\partial u} \frac{\partial {I}_{2}}{\partial u} + \frac{\partial {I}_{1}}{\partial v} \frac{\partial {I}_{2}}{\partial v}}{\sqrt{\frac{\partial {I}_{1}^{2}}{\partial u} + \frac{\partial {I}_{1}^{2}}{\partial v}} \sqrt{\frac{\partial {I}_{2}^{2}}{\partial u} + \frac{\partial {I}_{2}^{2}}{\partial v}}} .$$

h) Gradient Information with linear Scaling

$$GI 2 ( {I}_{1} , {I}_{2} ) = \frac{1}{N} {\sum }_{u , v ∈ I} g ( u , v ) min ( \sqrt{\frac{\partial {I}_{1}^{2}}{\partial u} + \frac{\partial {I}_{1}^{2}}{\partial v}} , α \sqrt{\frac{\partial {I}_{2}^{2}}{\partial u} + \frac{\partial {I}_{2}^{2}}{\partial v}} )$$

with

$$g ( u , v ) = \frac{θ ( u , v ) + 1}{2}$$

and

$$θ ( u , v ) = \frac{\frac{\partial {I}_{1}}{\partial u} \frac{\partial {I}_{2}}{\partial u} + \frac{\partial {I}_{1}}{\partial v} \frac{\partial {I}_{2}}{\partial v}}{\sqrt{\frac{\partial {I}_{1}^{2}}{\partial u} + \frac{\partial {I}_{1}^{2}}{\partial v}} \sqrt{\frac{\partial {I}_{2}^{2}}{\partial u} + \frac{\partial {I}_{2}^{2}}{\partial v}}}$$

and α as scaling factor.

Here are g(u, v) and θ(u, v) are examples of intermediate results for calculating the similarity measure derived from at least one of the sinograms a)-c). Where a) denotes the sinogram from step (S1); b) denotes the corrected sinogram from step (S3); and c) denotes the simulated sinogram.
i) Gradient Orientation

$$GO ( {I}_{1} , {I}_{2} ) = \frac{1}{max ( N , C 1 )} {\sum }_{u , v ∈ I : \sqrt{\frac{\partial {I}_{1}^{2}}{\partial u} + \frac{\partial {I}_{1}^{2}}{\partial v}} > t 1 ⋂ \sqrt{\frac{\partial {I}_{2}^{2}}{\partial u} + \frac{\partial {I}_{2}^{2}}{\partial v}} > t 2} \frac{2 - ( ln ( \vert {cos}^{- 1} ( θ ( u , v ) \vert + 1 ) )}{2}$$

$$with θ ( u , v ) = \frac{\frac{\partial {I}_{1}}{\partial u} \frac{\partial {I}_{2}}{\partial u} + \frac{\partial {I}_{1}}{\partial v} \frac{\partial {I}_{2}}{\partial v}}{\sqrt{\frac{\partial {I}_{1}^{2}}{\partial u} + \frac{\partial {I}_{1}^{2}}{\partial v}} \sqrt{\frac{\partial {I}_{2}^{2}}{\partial u} + \frac{\partial {I}_{2}^{2}}{\partial v}}} and scalar constants C 1 , t 1 , t 2.$$

j) Laplace of Gaussian

$$LoG {=}^{Δ} Δ {G}_{σ} ( u , v ) = \frac{{\partial }^{2}}{\partial {u}^{2}} {G}_{σ} ( u , v ) + \frac{{\partial }^{2}}{\partial {v}^{2}} {G}_{σ} ( u , v ) = \frac{{u}^{2} + {v}^{2} - 2 {σ}^{2}}{4 {σ}^{2}} {e}^{- ( {u}^{2} + {v}^{2} ) / 2 {σ}^{2}}$$

with

$${G}_{σ} ( u , v ) = \frac{1}{\sqrt{2 {πσ}^{2}}} exp ( - \frac{{u}^{2} + {v}^{2}}{2 {σ}^{2}} )$$

and the width of the Gaussian kernel σ.

### Examples on Histogram-Based Similarity Measures:

k) Mutual information

$$MI ( A , B ) = {\sum }_{a ∈ A , b ∈ B} p ( a , b ) log \frac{p ( a , b )}{p ( a ) p ( b )}$$

with p(a) as the probability for the occurrence of the value a in the input image I₁,
p(b) as the probability for the occurrence of the value b in the input image I₂ and p(a, b) as the conditional probability for the occurrence of the values a, b in the input images I₁ and I₂.

For example, the different evaluation of the partial regions in step (S5) during the calculation of the similarity measure can be implemented as follows:
a′) MSE(w I₁, w I₂),
where w is a pixel-wise weighting and w<=1 in the partial regions and w=1 in the remaining regions.
a″)

$$MSE ( {w}_{1} {f}_{11} ( {I}_{1} ) + {w}_{2} {f}_{12} ( {I}_{1} ) , {w}_{1} {f}_{21} ( {I}_{2} ) + {w}_{2} {f}_{22} ( {I}_{2} ) ) ,$$

where w₁ and w₂ are pixel-wise weights and for each pixel w₁+w₂=1 and f₁₁, f₁₂, f₂₁, f₂₂ are local filterings.
g′)

$$GI ( {I}_{1} , {I}_{2} ) = \frac{1}{N} {Σ}_{u , v ∈ I} w ( u , v ) g ( u , v ) min ( \sqrt{\frac{\partial {I}_{1}^{2}}{\partial u} + \frac{\partial {I}_{1}^{2}}{\partial v}} , \sqrt{\frac{\partial {I}_{2}^{2}}{\partial u} + \frac{\partial {I}_{2}^{2}}{\partial v}} ) ,$$

where w is a pixel-wise weighting and w<=1 in the partial regions and w=1 in the remaining regions.
k′) for the mutual information calculation p(a) is calculated from (w I₁) and p(b) is calculated from (w I₂) where w is a pixel-wise weighting [0, 1].

1. Method for geometric calibration of a DVT imaging in the dental field, comprising:
(S1) reconstructing a first volume from a sinogram with an initial projection geometry;
(S2) detecting metal regions in the sinogram;
(S3) correcting the metal regions in the sinogram;
(S4) reconstructing a second volume from the corrected sinogram from (S3) with an initial or a varied projection geometry;
(S5) geometrically calibrating by varying the projection geometry and evaluating by a similarity measure between a simulated sinogram of the reconstructed second volume and the sinogram or the corrected sinogram, wherein the simulated sinogram is calculated from the reconstructed second volume using the varied projection geometry, wherein at least a partial region of the following data:
a) sinogram from step (S1);
b) corrected sinogram from step (S3);
c) simulated sinogram;
d) intermediate result for calculating the similarity measure derived from at least one of said sinograms (a)-(c) is evaluated differently from the remaining regions of the data during the calculation of the similarity measure, said partial region including the metal regions from step (S2).

2. The method according to claim 1, wherein after (S5), (S6) repeating (S4)-(S5).

3. The method according to claim 1, further comprising:
after step (S5), the performing (S7) which repeats (S2)-(S5) or (S2)-(S6).

4. The method according to claim 1, further comprising:
after (S5), performing (S8) which includes reconstructing a third volume by taking into account the estimated projection geometry and applying a metal artifact correction.

5. The method according to claim 1, wherein detection of the metal regions in the sinogram in (S2) comprises:
(a) detecting the metal regions in the first volume;
(b) projecting the detected metal regions into the sinogram.

6. The method according to claim 1, wherein the detection of the metal regions in the sinogram in (S2) comprises:
(a′) generating a simulated sinogram of the first volume;
(b′) detecting the metal regions in the simulated sinogram of step (S2)(a) and transferring the detected metal regions to the sinogram.

7. The method according to claim 6, further comprising, performing after (S4), the following: (a) determining the metal regions in the second volume using the detected metal regions in the sinogram.

8. The method according to claim 5 wherein, after (S4), (b) correcting the metal regions in the second volume includes one or more of the following: (b1) filling the metal regions in the second volume with values from the reconstructed first volume or artificial values indicative of the metal regions; (b2) blending the values from (S4)(b1) with the values from the second volume in a weighted manner.

9. The method according to claim 1, wherein the correction of the metal regions in the sinogram in step (S3) comprises: (a) filling the metal regions in the corrected sinogram with new pixel values, which are either calculated from neighboring pixels or correspond to artificial pixel values; (b) weighted blending of new pixel values from step (S3)(a) with pixel values of the sinogram.

10. The method according to claim 1, wherein a different evaluation of at least a partial region of said data during the calculation of the similarity measure in step (S5) comprises a pixel-wise weighting, which is in a range of values 0 to 1.

11. The method according to claim 1, wherein a different evaluation of at least a partial region of said data during the calculation of the similarity measure in step (S5) comprises a local filtering.

12. A non-transitory computer-readable storage medium, including instructions that when executed by a computer, cause the computer to:
(S1) reconstruct a first volume from a sinogram with an initial projection geometry;
(S2) detect metal regions in the sinogram;
(S3) correct the metal regions in the sinogram;
(S4) reconstruct a second volume from the corrected sinogram from (S3) with an initial or a varied projection geometry;
(S5) geometrically calibrate by varying the projection geometry and evaluating by a similarity measure between a simulated sinogram of the reconstructed second volume and the sinogram or the corrected sinogram, wherein the simulated sinogram is calculated from the reconstructed second volume using the varied projection geometry, wherein at least a partial region of the following data:
a) sinogram from step (S1);
b) corrected sinogram from step (S3);
c) simulated sinogram;
d) intermediate result for calculating the similarity measure derived from at least one of said sinograms (a)-(c) is evaluated differently from the remaining regions of the data during the calculation of the similarity measure, said partial region including the metal regions from step (S2′).

13. A computerized DVT system comprising an X-ray device a processor; and a memory storing instructions that, when executed by the processor, configure the apparatus to
(S1) reconstruct a first volume from a sinogram with an initial projection geometry;
(S2) detect metal regions in the sinogram;
(S3) correct the metal regions in the sinogram;
(S4) reconstruct a second volume from the corrected sinogram from (S3) with an initial or a varied projection geometry;
(S5) geometrically calibrate by varying the projection geometry and evaluating by a similarity measure between a simulated sinogram of the reconstructed second volume and the sinogram or the corrected sinogram, wherein the simulated sinogram is calculated from the reconstructed second volume using the varied projection geometry, wherein at least a partial region of the following data:
a) sinogram from step (S1);
b) corrected sinogram from step (S3);
c) simulated sinogram;
d) intermediate result for calculating the similarity measure derived from at least one of said sinograms (a)-(c) is evaluated differently from the remaining regions of the data during the calculation of the similarity measure, said partial region including the metal regions from step (S2′).

14. (canceled)
